(19) United States
(12) Patent Application Publication
(10) Pub. No.: US 2024/0279040 A1
(43) Pub. Date: Aug. 22, 2024

(54) LIFT DEVICE

(71) Applicant: TEREX SOUTH DAKOTA, INC., Watertown, SD (US)

(72) Inventors: Kai WANG, Changzhou, Jiangsu (CN); Hao LIN, Changzhou, Jiangsu (CN); Lei SONG, Changzhou, Jiangsu (CN); Hongdong ZHANG, Changzhou, Jiangsu (CN); Daifeng ZHANG, Changzhou, Jiangsu (CN); James A. DONALDSON, Mesquite, NV (US)

(73) Assignee: TEREX SOUTH DAKOTA, INC., Watertown, SD (US)

(21) Appl. No.: 18/681,148

(22) PCT Filed: Aug. 5, 2021
(86) PCT No.: PCT/CN2021/110962

§ 371 Date: Feb. 5, 2024

(51) Int. Cl. B66F 11/04

(52) U.S. Cl. CPC B66F 11/042

(57) ABSTRACT

A lift device according to the disclosure may include a base, and a link arrangement including first and second links that are connected to the base at first and second fixed coupling locations, respectively. The lift device may further include a lifting mechanism coupled to the first and second links, wherein the lifting mechanism is movable between a stowed position and a deployed position. Furthermore, the first and second links are configured to pivot in opposite directions with respect to each other when the lifting mechanism moves between the stowed position and the deployed position.

### TECHNICAL FIELD

The disclosure relates to lift devices, such as aerial work platforms.

### BACKGROUND

A prior aerial work platform includes a base and a retractable lifting mechanism formed of a series of linked, foldable support members. The support members include a first pair of lower foldable support members pivotally coupled to the base at fixed pivot points, and a second pair of lower foldable support members that are slidably coupled to the base with rollers. In another embodiment, both pairs of lower foldable support members may be slidably coupled to the base. With such configurations, the connection between the lifting mechanism and the base may not be rigid.

Examples of prior aerial work platforms are disclosed in U.S. Patent Application Publication No. 2020/0399107 A1.

### SUMMARY

A lift device according to the disclosure may include a base, and a link arrangement including first and second links that are connected to the base at first and second fixed coupling locations, respectively. The lift device may further include a lifting mechanism coupled to the first and second links, wherein the lifting mechanism is movable between a stowed position and a deployed position. Furthermore, the first and second links are configured to pivot in opposite directions with respect to each other when the lifting mechanism moves between the stowed position and the deployed position.

A scissor lift according to the disclosure may include a base having first and second pairs of fixed articulation locations, and a link arrangement including first and second pairs of links that are pivotally connected to the first and second pairs of fixed articulation locations, respectively, and a coordination mechanism that is configured to coordinate movement of the first and second pairs of links. In addition, the scissor lift may include a retractable lifting mechanism having multiple foldable support members that are cooperable with each other so that the lifting mechanism is movable between a stowed position and an extended, deployed position, wherein the foldable support members include first and second pairs of lowermost foldable support members that are connected to the first and second pairs of links, respectively. A platform is coupled to an upper end of the lifting mechanism, and an actuator is coupled to at least one of the foldable support members for moving the lifting mechanism from the stowed position to the deployed position. The first pair of links is configured to pivot in a first direction and the second pair of links is configured to pivot in a second direction opposite the first direction when the lifting mechanism moves from the stowed position to the deployed position. Furthermore, position of a central plane of the lifting mechanism may remain substantially unchanged when the lifting mechanism moves between the stowed position and the deployed position.

Further according to the disclosure, a lift device may include a base having first and second fixed coupling locations, and a link arrangement including first and second links that are connected to the base at the first and second coupling locations, respectively. The lift device may also include a lifting mechanism coupled to the first and second links, wherein the lifting mechanism includes multiple foldable members and is movable between a stowed position and a deployed position. In addition, the lift device may include a platform coupled to an upper end of the lifting mechanism. The first and second links of the link arrangement are configured to pivot in opposite directions with respect to each other when the lifting mechanism moves between the stowed position and the deployed position. Furthermore, the link arrangement may be configured to cooperate with the lifting mechanism so that position of a central plane of the lifting mechanism, which passes between the first and second coupling locations, remains substantially unchanged when the lifting mechanism moves between the stowed position and the deployed position.

Still further according to the disclosure, a lift device may include a base, a lifting mechanism that is movable relative to the base between a stowed position and a deployed position, a link arrangement including first and second links, and a support assembly. Furthermore, 1) the first and second links may be connected to the base at first and second fixed coupling locations and may be further connected to a lower end of the lifting mechanism, or 2) the first and second links may be connected to the support assembly at first and second fixed coupling locations and may be further connected to an upper end of the lifting mechanism. In addition, the first and second links are configured to pivot in opposite directions with respect to each other when the lifting mechanism moves between the stowed position and the deployed position.

While exemplary embodiments are illustrated and disclosed, such disclosure should not be construed to limit the claims. It is anticipated that various modifications and alternative designs may be made without departing from the scope of the disclosure.

### BRIEF DESCRIPTION OF THE DRAWINGS

FIG. 1 is a perspective view of a lift device, according to the disclosure, including a base, a link arrangement coupled to the base, a lifting mechanism coupled to the link arrangement, and a support assembly or work platform assembly coupled to an upper end of the lifting mechanism, wherein the lifting mechanism and the link arrangement are each shown in a stowed position;

FIG. 2 is a perspective view of the lift device of FIG. 1 showing each of the lifting mechanism and the link arrangement in a deployed position;

FIG. 3 is a side view of the lift device of FIG. 1 showing each of the lifting mechanism and the link arrangement in the stowed position;

FIG. 4 is a side view of the lift device of FIG. 1 showing each of the lifting mechanism and the link arrangement in the deployed position;

FIG. 5 is a partial, exploded perspective view of the lift device of FIG. 1;

FIG. 6 is a perspective view of the link arrangement and the base of the lift device, showing the link arrangement in its stowed position;

FIG. 7 is a perspective view of the link arrangement and the base of the lift device, showing the link arrangement in its deployed position;

FIG. 8 is a side view of the link arrangement and a portion of the base, showing the link arrangement in a position between the stowed position and the deployed position;

FIG. 9 is a schematic view that corresponds to the link arrangement of FIG. 8;

FIG. 10 is a schematic view of a link arrangement according to the disclosure, showing a second embodiment of a timing mechanism of the link arrangement;

FIG. 11 is a schematic view of a link arrangement according to the disclosure, showing a third embodiment of a timing mechanism of the link arrangement;

FIG. 12 is a schematic view of a link arrangement according to the disclosure, showing a fourth embodiment of a timing mechanism of the link arrangement;

FIG. 13 is a schematic view of a link arrangement according to the disclosure, showing a fifth embodiment of a timing mechanism of the link arrangement;

FIG. 14 is a schematic view of a link arrangement according to the disclosure, showing a sixth embodiment of a timing mechanism of the link arrangement;

FIG. 15 is a perspective view of yet another embodiment of a link arrangement according to the disclosure;

FIG. 16 is a partial perspective view of another lift device according to the present disclosure including a link arrangement that connects a lifting mechanism to a support assembly or work platform assembly, wherein the lifting mechanism and the link arrangement are each shown in a stowed position; and

FIG. 17 is a partial perspective view of the lift device according to FIG. 16 showing each of the lifting mechanism and the link arrangement in a deployed position.

### DETAILED DESCRIPTION

As required, detailed embodiments are disclosed herein; however, it is to be understood that the disclosed embodiments are merely exemplary and that various and alternative forms may be employed. The figures are not necessarily to scale; some features may be exaggerated or minimized to show details of particular components. Therefore, specific structural and functional details disclosed herein are not to be interpreted as limiting, but merely as a representative basis for teaching one skilled in the art.

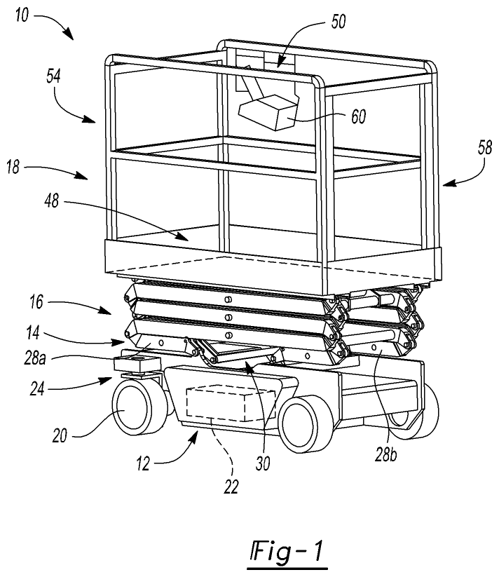

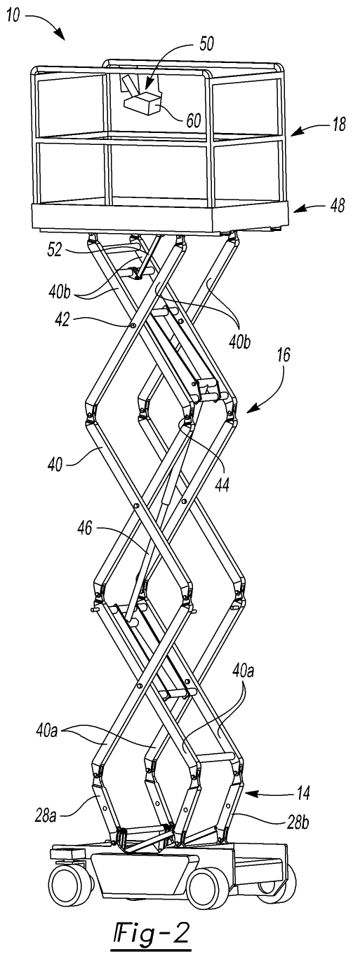

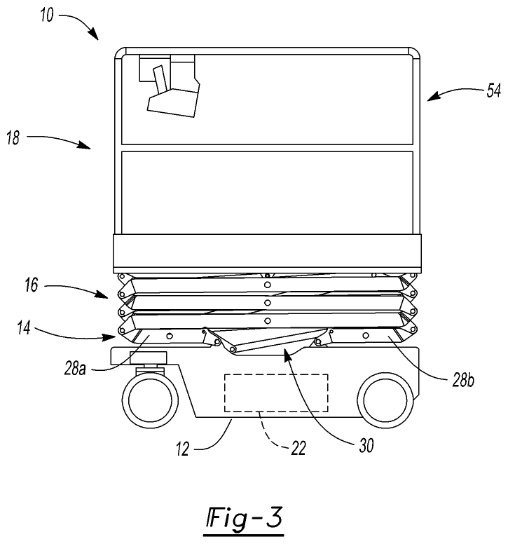

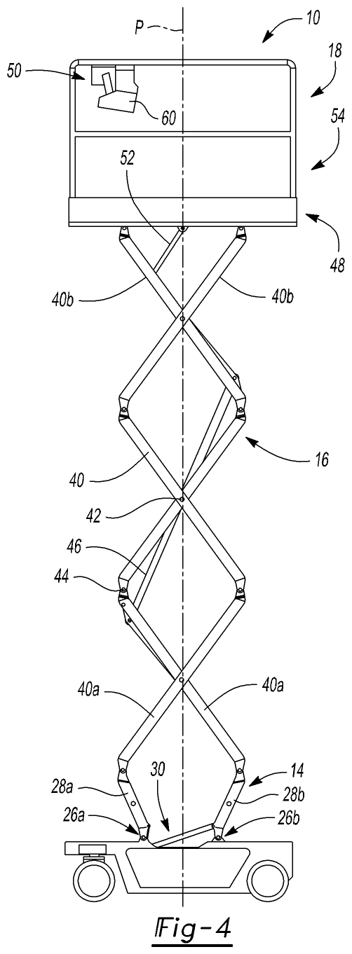

FIGS. 1-4 show a lift device 10, such as an aerial work platform, according to the disclosure. In the illustrated embodiment, the lift device 10 is formed as a scissor lift, having a base 12, a link arrangement 14 connected to the base 12, a retractable lifting assembly or mechanism 16 connected to the link arrangement 14, and a support assembly, such as work platform assembly 18, connected to the lifting mechanism 16. As will be explained below in greater detail, the lifting mechanism 16 is movable relative to the base 12 between a retracted or stowed position, shown in FIGS. 1 and 3, and a deployed position, shown in FIGS. 2 and 4, as well as to various positions located between the stowed position and the deployed position, in order to move the work platform assembly 18 to any one of multiple desired use positions. Furthermore, the link arrangement 14 and the lifting mechanism 16 are configured to cooperate together to control or otherwise influence or affect movement of the work platform assembly 18 when the lifting mechanism 16 moves between the stowed position and the deployed position.

The lift device 10 may be configured as a movable vehicle, for example. In that regard, the base 12 may be a vehicle body, frame or chassis, and the lift device 10 may be provided with one or more wheels 20, or other movement facilitating members such as tracks, movably coupled to the base 12. One or more of the wheels 20 (e.g., front wheels), or other movement facilitating members, may be driven by any suitable drive system 22, such as a combustion engine, one or more electric motors, etc., and directed by a steering system 24 so that the lift device 10 may be positioned at a desired location. Although the drive system 22 is schematically shown in FIGS. 1 and 3 as a single unit, the drive system 22 may include any suitable number of units (e.g., engines or motors). For example, the drive system 22 may include a separate electric motor provided for each front wheel 20, or a separate electric motor may be provided for each front wheel 20 and each rear wheel 20.

In another embodiment, the lift device 10 may be a stationary device. In such a case, the base 12 may be configured as a stationary support structure, for example.

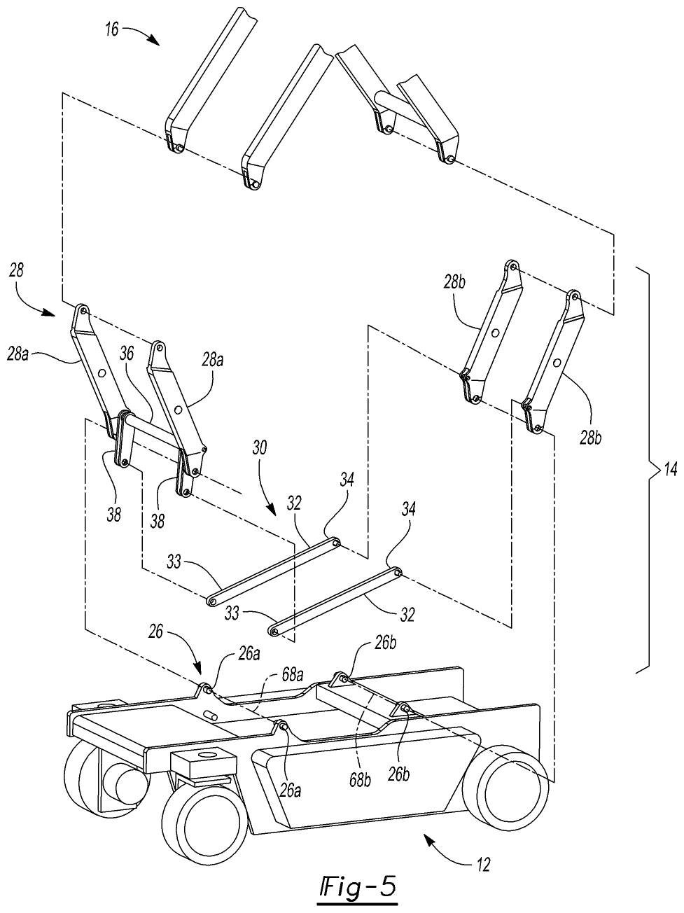

Referring to FIG. 5, the base 12 further includes two or more coupling or articulation locations 26 for coupling with the link arrangement 14. In the embodiment shown in FIG. 5, the base 12 includes first and second pairs (e.g., front and rear pairs) of fixed articulation locations 26a and 26b, respectively, that define fixed pivot points for connection with the link arrangement 14. For example, the articulation locations 26 may be formed in a body portion of the base 12 or in support members, such as brackets, that are attached to the body portion. Furthermore, the body portion and/or support members may be made of any suitable material, such as metal and/or composite material.

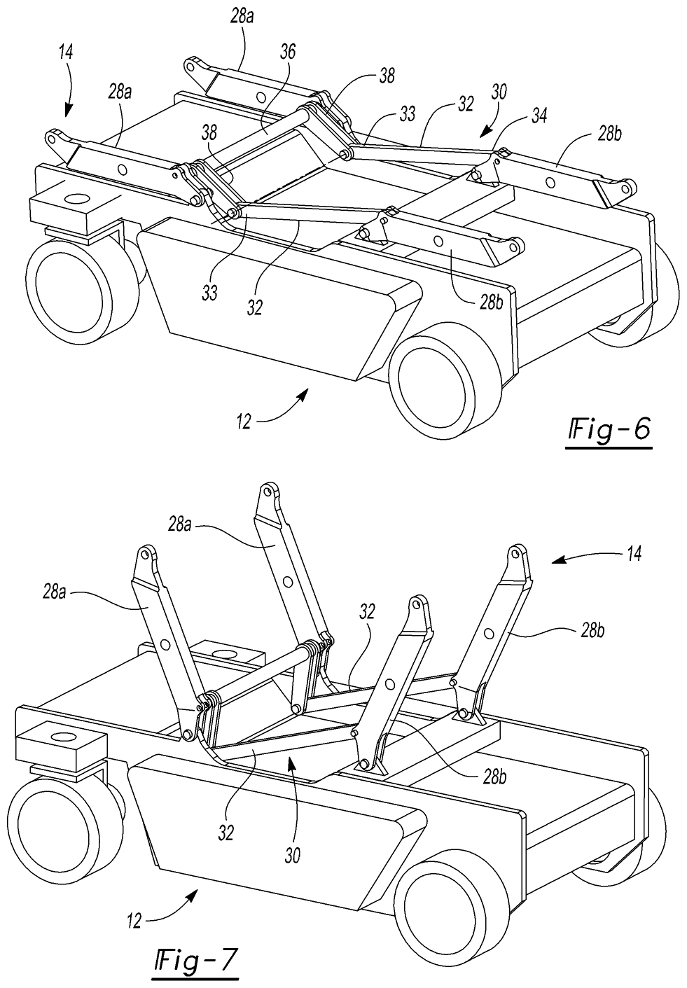

The link arrangement 14 includes two or more links 28 that each have a first portion or end connected to an articulation location 26 on the base 12, and a second portion or end connected to the lifting mechanism 16. In the embodiment shown in FIGS. 1-5, the link arrangement 14 includes first and second pairs (e.g., front and rear pairs) of links 28a and 28b, respectively, that are pivotally connected to the first and second pairs of fixed articulation locations 26a and 26b, respectively, in any suitable manner, such as with pivot pins or other connection members. Furthermore, the link arrangement 14 is movable relative to the base 12 between a stowed position shown, in FIG. 6, and a deployed position, shown in FIG. 7, when the lifting mechanism 16 moves between the stowed position and the deployed position.

The link arrangement 14 may further include a coordination mechanism or timing mechanism 30 associated with the links 28a, 28b of the link arrangement 14, and that is configured to coordinate (e.g., synchronize) movement of the links 28a, 28b. While the timing mechanism 30 may have any suitable configuration, in the embodiment shown in FIGS. 5-7, the timing mechanism 30 includes a pair of timing links 32 connected to the first and second pairs of links 28a and 28b, respectively. Specifically, each timing link 32 has a first end 33 connected to at least one of the first pair of links 28a, and a second end 34 connected to at least one of the second pair of links 28b. In the illustrated embodiment, the first pair of links 28a are fixedly connected together by a laterally extending member 36 (e.g., rod, bar, etc.), and the first end 33 of each timing link 32 is pivotally connected to a respective downwardly extending link 38 that is fixedly connected to the laterally extending member 36. For example, the first end 32 of each timing link 32 may be pivotally connected to a respective link 38 with a pivot pin or other connection member. Furthermore, the second end 34 of each timing link 32 is pivotally connected directly to a respective one of the second pair of links 28b, such as with a pivot pin or other connection member.

Referring to FIGS. 1-4, the lifting mechanism 16 is coupled to the link arrangement 14 so that the lifting mechanism 16 is movable with the link arrangement 14. In the illustrated embodiment, the lifting mechanism 16 is a scissor lift structure formed of a series of linked, foldable support members 40, such as rigid elements like bars, rods, etc., that are cooperable with each other to enable the lifting mechanism 16 to move between the stowed and deployed positions. Furthermore, in the illustrated embodiment, the lifting mechanism 16 includes two groups or sets of such support members 40, with one set on each side of the lift device 10. The support members 40 of each set may be connected together using any suitable connection members, such as intermediate or central pivot pins 42 and outer pivot pins 44. The central pivot pins 42 and the outer pivot pins 44 extend through adjacent support members 40 to pivotally couple the support members 40. The two sets of support members 40 may also be connected together using any suitable connection members, such as laterally extending rods, bars or braces. The support members 40 may include two or more support members 40 that are coupled to the link arrangement 14, and two or more support members 40 that are coupled to the work platform assembly 18. In the illustrated embodiment, the support members 40 include first and second pairs (e.g., front and rear pairs) of lowermost support members 40a pivotally coupled to the first and second pairs of links 28a and 28b, respectively, of the link arrangement 14, such as with pivot pins or other connection members, and first and second pairs (e.g., front and rear pairs) of uppermost support members 40b pivotally coupled to the work platform assembly 18.

The lift device 10 further includes one or more actuators, such as hydraulic cylinders, pneumatic cylinders, electric linear actuators, etc., associated with the lifting mechanism 16 and configured to move the lifting mechanism 16 from the stowed position to the deployed position or between the stowed position and the deployed position. In the illustrated embodiment, the lift device 10 includes an actuator 46 mounted to different support members 40 or different pairs of support members 40. Specifically, the actuator 46 has a first end connected between a pair (e.g., the second pair) of the lowermost support members 40a (e.g., connected to a laterally extending member, such as a rod, bar or brace, that is connected to the pair of lowermost support members 40a) and a second end connected between a pair (e.g., the first pair) of the uppermost support members 40b (e.g., connected to a laterally extending member, such as a rod, bar or brace, that is connected to the pair of uppermost support members 40b). Furthermore, the actuator 46 is movable between a retracted position and an extended position for moving the lifting mechanism 16 from the stowed position to the deployed position.

In another embodiment, the lift device 10 may include one or more actuators connected between the base 12 and one or more of the support members 40. In yet another embodiment, the lift device 10 may include one or more actuators connected between the link arrangement 14 and one or more of the support members 40. In still yet another embodiment, the lift device 10 may include any combination of the above described actuators. For example, the lift device 10 may include one or more actuators connected between the base 12 and one or more of the support members 40, one or more actuators connected between the link arrangement 14 and one or more of the support members 40, and/or one or more actuators mounted to different support members 40. In any case, the one or more actuators for moving the lifting mechanism 16 may be considered part of the lifting mechanism 16.

The work platform assembly 18 is coupled to the lifting mechanism 16 and includes a support member, such as base or work platform 48, and a control system 50 associated with the platform 48 for controlling operation of the lift device 10 (e.g., operation of the drive system 22, operation of the steering system 24, movement of the platform 48 via the link arrangement 14 and the lifting mechanism 16 and/or movement of the platform 48 with respect to the lifting mechanism 16). While the work platform assembly 18 may be coupled to the lifting mechanism 16 in any suitable manner, in the illustrated embodiment, the platform 48 has first and second pairs (e.g., front and rear pairs) of slidable connection locations (e.g., slider rails) connected to the first and second pairs (e.g., front and rear pairs) of uppermost support members 40b. Each slidable connection location may receive a roller or other slidable element connected to a respective uppermost support member 40b. A bracing element 52 (e.g., link) is also pivotally connected to a central portion of the platform 48 and to a laterally extending member that extends between a pair of the uppermost support members 40b. In another embodiment, the platform 48 may have a pair of fixed coupling or articulation locations that are pivotally connected to one pair (e.g., front pair) of the uppermost support members 40b, and a pair of slidable connection locations (e.g., slider rails) connected to the other pair (e.g., rear pair) of the uppermost support members 40b.

The platform 48 of the work platform assembly 18 is sized to receive an operator thereon. A railing assembly or frame assembly 54 is provided on the platform 48, and the frame assembly 54 includes one or more guard members or rails (e.g., toe-boards, middle rails and top rails) that cooperate to contain the operator within the frame assembly 54. The frame assembly 54 may also include a movable (e.g., pivotable) door 58 to allow operator ingress to, and egress from, the work platform assembly 18.

The control system 50 may include any suitable controls for controlling operation of the lift device 10. For example, the control system 50 may include a control unit 60 (e.g., electronic control unit, control box or control panel) mounted on or supported by the platform 48 and having one or more controls, such as buttons, switches, wheels, levers (e.g., joysticks), etc., for inputting control commands. The control system 50 may also include one or more other control units positioned at other locations on the lift device 10. Furthermore, the control system 50 may include any suitable hardware and/or software for controlling operation of any of the above described systems, mechanisms, arrangements or other components. For example, the control system 50 may include one or more processors in communication with, or configured to communicate with, one or more storage devices or memory units, which include computer readable program instructions that are executable by the one or more processors so that the control system 50 may control operation of the lifting mechanism 16, the drive system 22, the steering system 24, etc. The control system 50 may also, or instead, include one or more application specific integrated circuits, programmable gate arrays, programmable logic devices, and/or digital signal processors.

Referring to FIGS. 1-7, operation of the lift device 10 will now be described in more detail. When the lift device 10 is located in a desired position and suitably supported or otherwise braced, the operator may enter the work platform assembly 18 through the door 58. The operator may then move the work platform assembly 18 using the controls of the control unit 60. For example, the control unit 60 may be used to control operation of the actuator 46 so that the lifting mechanism 16 may be raised from the stowed position to the deployed position.

As mentioned above, the link arrangement 14 and the lifting mechanism 16 are configured to cooperate together when the lifting mechanism 16 moves between the stowed position and the deployed position. Referring to FIG. 4, for example, the link arrangement 14 may be configured to cooperate with the lifting mechanism 16 so that position of a central plane P of the lifting mechanism 16 (which passes between the first and second pairs of articulation locations 26a and 26b, respectively, of the base 12, and through one or more central points of the lifting mechanism 16 when viewed from a side of the lifting mechanism 16), relative to the base 12, remains substantially unchanged when the lifting mechanism 16 moves between the stowed position and the deployed position. In that regard, for example, the link arrangement 14 and the lifting mechanism 16 may cooperate together so that the central plane P tilts less than +/−5°, or less than +/−3°, or less than +/−1°, or less than +/−0.5°, from a bottom or lower end of the lifting mechanism 16 to a top or upper end of the lifting mechanism 16 when the lifting mechanism 16 moves from the stowed position to the deployed position (or any position between the stowed position and the deployed position, such as a middle position), and/or so that the position of a portion of the central plane P (e.g., a point or a line on the central plane P that corresponds to the lower end of the lifting mechanism 16) moves less than +/−4 inches (+/−10.16 cm), or less than +/−2 inches (+/−5.08 cm), or less than +/−1 inch (+/−2.54 cm), or less than +/−0.5 inches (+/−1.27 cm), when the lifting mechanism 16 moves from the stowed position to the deployed position.

Referring to FIGS. 6 and 7, the first pair of links 28a and the second pair of links 28b of the link arrangement 14 pivot in opposite directions when the lifting mechanism 16 moves between the stowed position and the deployed position. Furthermore, the timing mechanism 30 of the link arrangement 14 is configured to coordinate movement of the links 28a, 28b when the lifting mechanism 16 moves between the stowed position and the deployed position. In that regard, the timing links 32 of the timing mechanism 30 may coordinate or control movement of the links 28a, 28b so that the first pair of links 28a pivots substantially synchronously (e.g., at substantially the same speed) with the second pair of links 28b. For example, the pivot speed of the first pair of links 28a may be within +/−10% or +/−5% or +/−2% or +/−0.5% of the pivot speed of the second pair of links 28b.

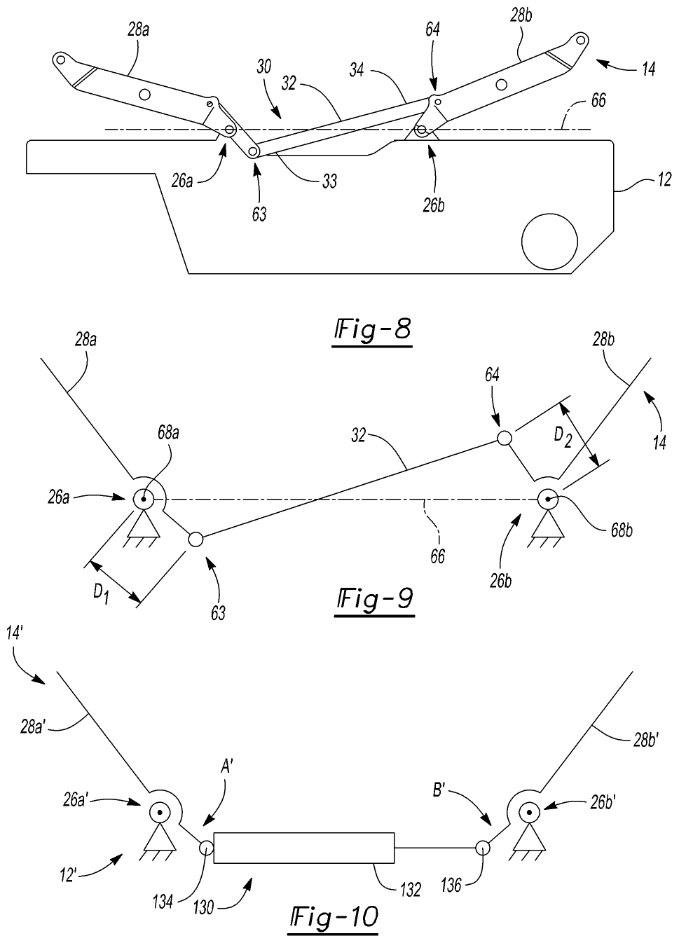

Referring to FIGS. 8 and 9, additional details of the link arrangement 14 and associated timing mechanism 30 will now be discussed. For each timing link 32, the first and second ends 33 and 34, respectively, define first and second connection locations 63 and 64, respectively. One of the first and second connection locations 63, 64 is positioned below a plane 66 that extends through the fixed articulation locations 26a, 26b of the base 12, and the other of the first and second connection locations 63, 64 is positioned above the plane 66. Furthermore, the connection locations 63, 64 may remain on opposite sides of the plane 66 when the link arrangement 14 moves between its stowed and deployed positions (i.e., when the lifting mechanism 16 moves between the stowed and deployed positions).

Referring to FIG. 9, the first and second fixed articulation locations 26a and 26b, respectively, of the base 12 define first and second pivot axes 68a and 68b, respectively (see also FIG. 5), that are parallel to each other and spaced apart from each other. For each timing link 32, when the lift device 10 is viewed in a direction parallel to the first and second pivot axes 68a and 68b, respectively, (e.g., viewed from a side of the lift device 10), a first distance D₁ between the first fixed coupling location 26a and the first connection location 63 may be substantially equal to a second distance D₂ between the second fixed coupling location 26b and the second connection location 64. For example, the distances D₁, D₂ may be equal, or the first distance D₁ may be within +/−10% or +/−5% or +/−2% or +/−0.5% of the second distance D₂.

In addition, the links 28 of the link arrangement 14 may be symmetrical. More specifically, the links 28a may be symmetrical with respect to the links 28b (e.g., each of the links 28a may have a length from a respective coupling location 26a to a coupling location with a respective support member 40a that is substantially equal to a length of each link 28b from a respective coupling location 26b to a coupling location with a respective support member 40a). With such a configuration, the above described timing links 32 may effectively coordinate movement of the links 28 when the lifting mechanism 16 moves between the stowed and deployed positions.

The lift device 10 according to the disclosure may provide numerous benefits compared to prior lift devices. For example, because the link arrangement 14 is connected to the base 12 at fixed articulation locations 26, the link arrangement 14 may provide a more rigid connection between the lifting mechanism 16 and the base 12. As a result, stability (e.g., side stability) and operation feeling of the lift device 10 may be improved. Furthermore, the timing mechanism 30 of the link arrangement 14 may coordinate movement of the links 28 so that position of the central plane P of the lifting mechanism 16 relative to the base 12 may remain substantially unchanged as the lifting mechanism 16 moves between the stowed and deployed positions. In addition, because the lift device 10 may be provided without any slider channels at the base 12, repair and maintenance of traditional sliding members, such as rollers and pads, may be eliminated, and more design freedom with respect to the base configuration may be provided. Still further, the link arrangement 14 may add additional lift height to the lifting mechanism 16, which may allow a reduction in number and/or size of foldable members in the lifting mechanism 16 to achieve a desired lift height.

As mentioned above, the timing mechanism 30 may have any suitable configuration for coordinating movement of the links 28 of the link arrangement 14. FIGS. 10-14 show schematic representations of other example timing mechanism embodiments. Furthermore, those figures show a single first link 28a′ and a single second link 28b′ of a link arrangement 14′, and the links 28a′, 28b′ may be symmetrical (e.g., the links 28a′, 28b′ may have the same length, but mirror configurations). It should be understood that the above described timing mechanism 30, as well as any of the below described embodiments, may be used with any suitable link arrangement according to the disclosure having one or more first links and one or more second links. For example, any of the below described embodiments may be used with a link arrangement having a pair of first links and a pair of second links, so that the same or similar base and lifting mechanism configurations described above may be used with the below embodiments. In the case of a link arrangement having a single first link and a single second link, base and lifting mechanism configurations may be modified or adjusted as needed to accommodate interaction with the first link and the second link. For example, a base may be provided with first and second fixed articulation locations (e.g., front and rear fixed articulation locations) that are connectable to such first and second links, respectively, and a lifting mechanism may be provided with first and second lowermost support members (e.g., front and rear support members) that are also connectable to the first and second links.

In the timing mechanism embodiment shown in FIG. 10, timing mechanism 130 includes an actuator 132, such as a hydraulic cylinder, pneumatic cylinder, electric linear actuator, etc., having a first end 134 connected (e.g., pivotally connected) to the first link 28a′, and a second end 136 connected (e.g., pivotally connected) to the second link 28b′. In this embodiment, a suitable control system, such as the control system 50 mentioned above, may function to control the actuator 132 and an actuator (e.g., actuator 40) of a corresponding lifting mechanism (e.g., lifting mechanism 16) so that movement of the actuators may be coordinated (e.g., synchronized). For example, the control system may control extending speed and retracting speed of the actuator 132 so that those speeds correspond to extending speed and retracting speed, respectively, of the actuator of the lifting mechanism. Furthermore, in the illustrated embodiment, first link member or arm A′ (which may, for example, be part of the first link 28a′, or another link fixedly connected with respect to the first link 28a′) and second link member or arm B′ (which may, for example, be part of the second link 28b′, or another link fixedly connected with respect to the second link 28b′) have the same length. In another embodiment, the first arm A′ and the second arm B′ may have different lengths, and size and/or operating speed of the actuator 132 may be adjusted so that movement of the links 28a′, 28b′ is coordinated (e.g., synchronized) and related to movement of the corresponding lifting mechanism.

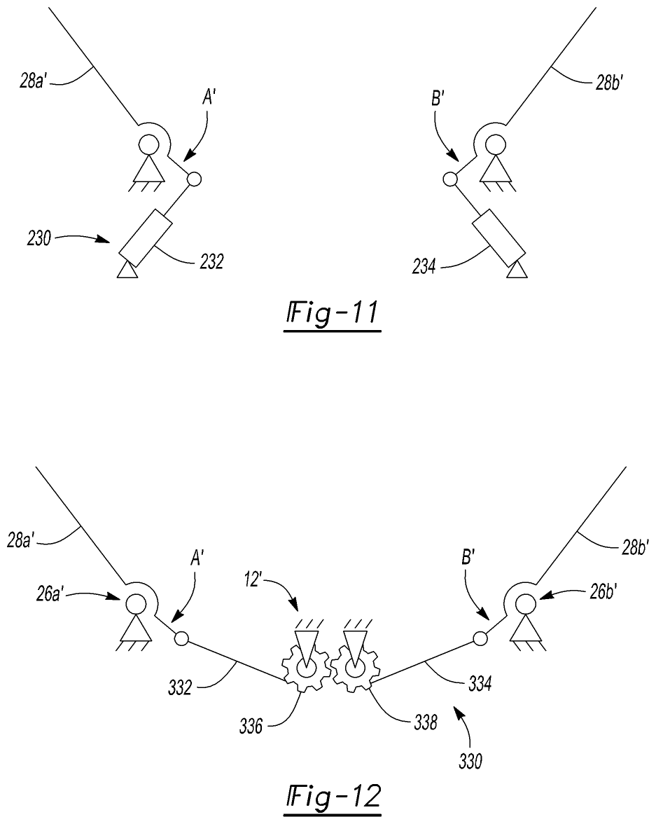

In the timing mechanism embodiment shown in FIG. 11, timing mechanism 230 includes a first actuator 232 connected to the first link 28a′, and a second actuator 234 connected to the second link 28b′. Opposite ends of the actuators 232, 234 may also be connected to base 12′. Each of these actuators 232, 234 may likewise be any suitable actuator, such as a hydraulic cylinder, pneumatic cylinder, electric linear actuator, etc. In the illustrated embodiment, the first and second arms A′ and B′, respectively, have the same length, and the first and second actuators 232 and 234, respectively, also have the same length. Furthermore, the actuators 232, 234 may be controlled so that they rotate the first and second links 28a′ and 28b′, respectively at substantially the same speed but in opposite directions. For example, the actuators 232, 234 may be controlled through a hydraulic circuit or by a control system, such as the above described control system 50. In another embodiment, the arms A′, B′ may have different lengths, and operation of the actuators 232, 234 may be adjusted accordingly to coordinate (e.g., synchronize) rotation of the links 28a′, 28b′ (e.g., so that the links 28a′, 28b′ rotate at substantially the same speed but in opposite directions).

In other embodiments, a timing mechanism may be provided with first and second timing links, wherein the first timing link has a first end connected to the first link 28a′ and a second end movably associated with base 12′, and the second timing link has a first end connected to the second link 28b′ and a second end movably associated with the base 12′. In the embodiment shown in FIG. 12, for example, timing mechanism 330 includes two such timing links, e.g., first timing link 332 and second timing link 334 that each have first and second ends. In the illustrated embodiment, the first and second arms A′ and B′, respectively, have the same length, and the first and second a timing links 332 and 334, respectively, also have the same length. The timing mechanism 330 further includes first and second gears 336 and 338, respectively that are engageable with each other and rotatably coupled to the base 12′ (e.g., symmetrically located with respect to fixed articulation locations 26a′, 26b′ on the base 12′). The second end of the first timing link 332 is connected (e.g., pivotally connected) to the first gear 336, and the second end of the second timing link 334 is connected (e.g., pivotally connected) to the second gear 336. When the associated lifting mechanism (e.g., lifting mechanism 16) is moved between the stowed position and the deployed position, that movement also causes the links 28a′, 28b′ to move, which causes the timing links 332, 334 to move and thereby rotate the gears 336, 338. Interaction of the gears 336, 338 results in controlled, coordinated (e.g., synchronized) movement of the links 28a′, 28b′.

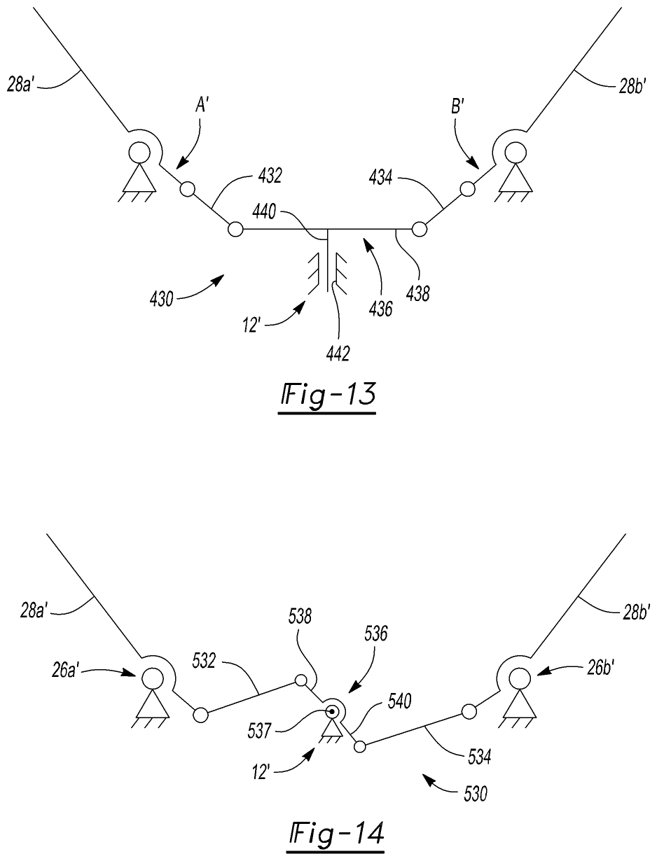

In the embodiment shown in FIG. 13, timing mechanism 430 also includes two such timing links as mentioned above, e.g., first and second timing links 432 and 434, respectively, that each have first and second ends. The timing mechanism 430 further includes a movable guide member 436 mounted on the base 12′ so that the guide member 436 is movable with respect to the base 12′ in upward and downward directions, for example. In the illustrated embodiment, the guide member 436 includes a laterally extending link 438 connected to a vertically extending member 440, such as a rod or bar, that is received in, or otherwise cooperates with, a guide element 442, such as a guide channel, formed in the base 12′ or in a component attached to the base 12′. The second end of the first timing link 432 is connected to a first portion of the guide member 436 (e.g., first end of the laterally extending link 438), and the second end of the second timing link 434 is connected to a second portion of the guide member 436 (e.g., second end of the laterally extending link 438). When the associated lifting mechanism (e.g., lifting mechanism 16) is moved between the stowed position and the deployed position, movement of the links 28a′, 28b′ is coordinated or controlled by constrained movement of the guide member 436 with respect to the guide element 442. In another embodiment, the guide member 436 may have multiple portions that are movably linked together, and each portion may be received in, or otherwise cooperate with, a guide element, such as a guide channel, formed in the base 12′ or in a component attached to the base 12′.

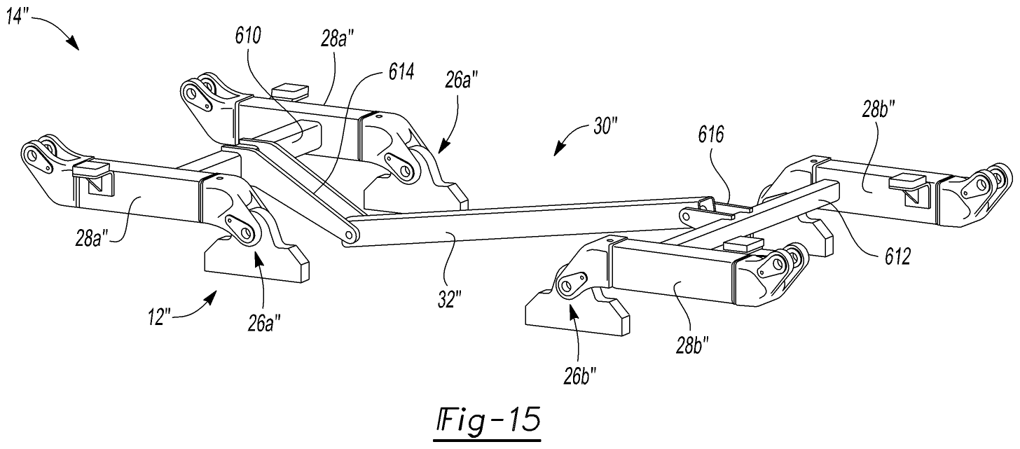

In the embodiment shown in FIG. 14, timing mechanism 530 also includes two such timing links as mentioned above, e.g., first and second timing links 532 and 534, respectively, that each have first and second ends. The timing mechanism 530 further includes a rotatable member 536, such as a pivot arm, rotatably mounted on the base 12′ at an articulation location that defines a pivot axis 537, and the rotatable member 536 has first and second portions or sections 538 and 540, respectively, that extend away from the pivot axis 537 in opposite directions. The second end of the first timing link 532 is pivotally connected to the first section 538 of the rotatable member 536 (e.g., first end of the rotatable member 536), and the second end of the second timing link 534 is pivotally connected to the second section 540 of the rotatable member 536 (e.g., second end of the rotatable member 536). In the illustrated embodiment, the timing links 532, 534 have the same length, and the sections 538, 540 of the rotatable member 536 have the same length. In another embodiment, however, the timing links 532, 534 may have different lengths, and the sections 538, 540 of the rotatable member 536 may also have different lengths.

As mentioned above, any of the disclosed timing mechanism embodiments may be used with any suitable link arrangement according to the disclosure having one or more first links and one or more second links. For example, if any of the embodiments shown in FIGS. 10-14 were used with a link arrangement having a pair of first links and a pair of second links, the respective timing mechanism could also be provided as a pair of timing mechanisms so that one of the pair of timing mechanisms could be connected to one first link of the pair of first links and one second link of the pair of second links, and the other timing mechanism could be connected to the other first link of the pair of first links and the other second link of the pair of second links. As another example, the pair of first links could be fixedly joined together (e.g., by a laterally extending member) and the pair of second links could also be fixedly joined together (e.g., by a laterally extending member) so that a single timing mechanism could be connected between the pair of first links and the pair of second links.

As a more detailed example, FIG. 15 shows a link arrangement 14″ having first and second pairs (e.g., front and rear pairs) of links 28a″ and 28b″, respectively, wherein the first pair of links 28a″ is fixedly connected together by a first laterally extending member 610 (e.g., rigid rod, bar, etc.) and the second pair of links 28b″ is fixedly connected together by a second laterally extending member 612 (e.g., rigid rod, bar, etc.). Furthermore, the first and second pairs of links 28a″ and 28b″, respectively, are pivotally connected to first and second pairs of fixed articulation locations 26a″ and 26b″, respectively, formed on base 12″. In addition, the link arrangement 14″ includes a timing mechanism 30″ having a single timing link 32″ that is connected between the first and second pairs of links 28a″ and 28b″, respectively. In the illustrated embodiment, a first end of the timing link 32″ is pivotally connected to a downwardly extending first connection member 614 (e.g., bar, bracket, etc.) that is fixedly connected to the first laterally extending member 610, and a second end of the timing link 32″ is pivotally connected to a second connection member 616 (e.g., bar, bracket, etc.) that is fixedly connected to the second laterally extending member 612. With such a configuration, the single timing link 32″ can coordinate movement of both pairs of links 28a″, 28b″.

It should be noted that any of the above described components may be made of any suitable material and in any suitable manner. For example, components of any of the above-described link arrangements may be made of metal and/or composite material, such as steel, ductile iron, aluminum, carbon fiber, fiberglass plastic, etc. As a more detailed example, link members of the link arrangements may be made of stamped metal, steel tubing, or cast steel.

It should also be noted that any of the above described link arrangement embodiments could be used for coupling a lifting mechanism (e.g., lifting mechanism 16) and a support assembly (e.g., work platform assembly 18) of a lift device (e.g., lift device 10). For example, any of the above described link arrangement embodiments could be flipped over and connected between a lifting mechanism and support assembly or work platform assembly. Depending on the configuration of the lifting mechanism (e.g., whether the lifting mechanism includes one or two groups or sets of foldable members), a support member such as a platform of the support assembly may be provided with two or more fixed coupling or articulation locations, and the link arrangement may likewise be provided with two or more links for connection with the articulation locations.

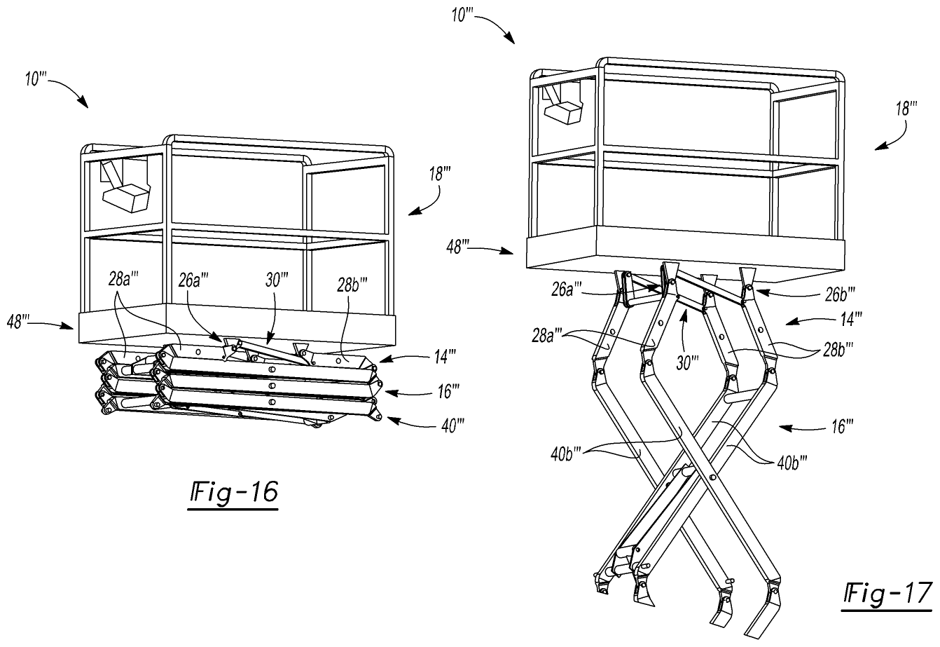

As a more detailed example, FIGS. 16 and 17 show a lift device 10′″ according to the disclosure including a link arrangement 14′″ that connects a lifting mechanism 16′″ to a support assembly or work platform assembly 18′″. The lifting mechanism 16′″ includes two groups or sets of foldable support members 40″, with one set on each side of the lift device 10″, the work platform assembly 18″ includes a support member or platform 48′″ that is provided with first and second pairs (e.g., front and rear pairs) of fixed articulation locations 26a″ and 26b″″, respectively, that define fixed pivot points, and the link arrangement 14″ is likewise provided with first and second pairs (e.g., front and rear pairs) of links 28a′″ and 28b″, respectively, that are connected between the fixed articulation locations 26a″, 26b′″ and uppermost support members 40b′″ of the lifting mechanism 16″. Specifically, the first and second pairs of links 28a″ and 28b″, respectively, are pivotally connected (e.g., with pivot pins or other connection members) to the first and second pairs of fixed articulation locations 26a′″ and 26b″″, respectively, of the platform 48″. Such articulation locations 26a″, 26b′″ may be formed in a body portion of the platform 48′″ or in support members, such as brackets, that are attached to the body portion, for example. Furthermore, the first and second pairs of links 28a′″ and 28b″, respectively, of the link arrangement 14′″ are pivotally connected (e.g., with pivot pins or other connection members) to first and second pairs (e.g., front and rear pairs), respectively, of uppermost support members 40b″ of the lifting mechanism 16″. In addition, the link arrangement 14′″ may include a coordination mechanism or timing mechanism for coordinating (e.g., synchronizing) movement of the links 28a′″, 28b′″ of the link arrangement 14′″ as the link arrangement 14″ and the lifting mechanism 16″ each move between a stowed position, shown in FIG. 16, and a deployed position, shown in FIG. 17. In the illustrated embodiment, the link arrangement 14″ includes a coordination mechanism or timing mechanism 30″ that is similar to the timing mechanism 30 described above in detail, and the timing mechanism 30′″ operates in a similar manner as the timing mechanism 30 such that further description of the timing mechanism 30′″ is not necessary.

In other embodiments, the link arrangement 14″ of the lift device 10′″ may include any suitable coordination or timing mechanism, such as any of the timing mechanism embodiments described above and/or shown in FIGS. 10-15. It should be noted that where an above described timing mechanism embodiment includes one or more components connected to a base, such as base 12′ (e.g., the embodiments shown in FIGS. 11-14), such components could instead be connected to the work platform assembly 18″ (e.g., platform 48″) when the timing mechanism is used with the lift device 10″.

The lift device 10″ may further include a base (not shown) that is the same or similar to the above described base 12, base 12′ or base 12″, and a link arrangement that is the same or similar to the above described link arrangement 14, link arrangement 14′ or link arrangement 14″ for connecting the base to a lower end of the lifting mechanism 16″ in the same or similar manner as described above in detail. Alternatively, the lift device 10′″ may include a base that is connected to the lower end of the lifting mechanism 16″ in any suitable manner.

Therefore, a lift device according to the disclosure may include a link arrangement according to the disclosure for coupling a base to a lifting mechanism, or for coupling the lifting mechanism to a support assembly, such as a work platform assembly. Furthermore, a lift device according to the disclosure may include a first link arrangement according to the disclosure for coupling a base to a lifting mechanism, and a second link arrangement according to the disclosure for coupling the lifting mechanism to support assembly, such as a work platform assembly.

Aspects of some embodiments according to the disclosure are provided in the below paragraphs.

A lift device according to the disclosure may include a base, a lifting mechanism that is movable relative to the base between a stowed position and a deployed position, a link arrangement including first and second links, and a support assembly. Furthermore, 1) the first and second links may be connected to the base at first and second fixed coupling locations and may be further connected to a lower end of the lifting mechanism, or 2) the first and second links may be connected to the support assembly at first and second fixed coupling locations and may be further connected to an upper end of the lifting mechanism. In addition, the first and second links are configured to pivot in opposite directions with respect to each other when the lifting mechanism moves between the stowed position and the deployed position.

The lift device of paragraph wherein the first and second links are connected to the support assembly at the first and second fixed coupling locations and are further connected to the upper end of the lifting mechanism.

The lift device of paragraph wherein the link arrangement comprises a timing link connected to the first and second links.

The lift device of paragraph wherein the link arrangement comprises an actuator having a first end connected to the first link and a second end connected to the second link.

The lift device of paragraph wherein the link arrangement comprises a first actuator pivotally connected to the first link, and a second actuator pivotally connected to the second link.

The lift device of paragraph wherein the link arrangement comprises first and second gears rotatably mounted on the support assembly, and first and second timing links, wherein the first timing link has a first end connected to the first link and a second end connected to the first gear, and the second timing link has a first end connected to the second link and a second end connected to the second gear.

The lift device of paragraph wherein the link arrangement comprises first and second timing links, and a movable guide member mounted on the support assembly so that the guide member is movable along a plane located between the first and second fixed coupling locations, wherein the first timing link has a first end connected to the first link and a second end connected to the movable guide member, and the second timing link has a first end connected to the second link and a second end connected to the movable guide member.

The lift device of paragraph wherein the link arrangement comprises first and second timing links, and a pivot arm pivotally mounted on the support assembly, wherein the first timing link has a first end connected to the first link and a second end connected to the pivot arm, and the second timing link has a first end connected to the second link and a second end connected to the pivot arm.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1. A lift device comprising:
a base;
a link arrangement including first and second links that are spaced apart from each other and pivotally connected to the base at first and second fixed coupling locations, respectively, and a timing mechanism associated with the first and second links and configured to coordinate movement of the first and second links so that the first and second links are pivotable substantially synchronously, wherein the timing mechanism defines a connection location with respect to one of the first and second links that is located below a plane that extends through the first and second fixed coupling locations; and
a lifting mechanism including first and second support members pivotally coupled together with a central pivot pin and pivotally coupled to the first and second links, respectively, wherein the lifting mechanism is movable between a stowed position and a deployed position;
wherein the first and second links are configured to pivot about first and second pivot axes, respectively, and in opposite directions with respect to each other, without overlapping each other when viewed in a direction parallel to the first and second axes, when the lifting mechanism moves between the stowed position and the deployed position.

2. The lift device of claim 1 further comprising an actuator associated with the lifting mechanism and configured to move the lifting mechanism from the stowed position to the deployed position, wherein the actuator is separate from the timing mechanism.

3. The lift device of claim 2 wherein the timing mechanism comprises a timing link connected to the first and second links.

4. The lift device of claim 3 wherein the timing link has first and second ends that define first and second connection locations, respectively, and wherein one of the first and second connection locations is positioned below a plane that extends through the first and second fixed coupling locations, and the other of the first and second connection locations is positioned above the plane.

5. The lift device of claim 4 wherein the first and second fixed coupling locations define the first and second pivot axes, respectively, and wherein, when the lift device is viewed in a direction parallel to the first and second pivot axes, a first distance between the first fixed coupling location and the first connection location is substantially equal to a second distance between the second fixed coupling location and the second connection location.

6. The lift device of claim 1 wherein the link arrangement further comprises an additional first link pivotally connected to the base at an additional first coupling location, a laterally extending member fixedly connected to the first link and the additional first link, and a downwardly extending link that is fixedly connected to the laterally extending member, and wherein the timing mechanism comprises a timing link having a first end pivotally connected to the downwardly extending link and a second end connected to the second link.

7. The lift device of claim 1 wherein the timing mechanism comprises an actuator connected to the first and second links.

8. The lift device of claim 1 wherein the timing mechanism comprises a first actuator connected to the first link, and a second actuator connected to the second link.

9. The lift device of claim 1 wherein the timing mechanism comprises first and second timing links, the first timing link has a first end connected to the first link and a second end movably associated with the base, and the second timing link has a first end connected to the second link and a second end movably associated with the base.

10. The lift device of claim 9 wherein the timing mechanism further comprises first and second gears that are engageable with each other and rotatably coupled to the base, wherein the second end of the first timing link is connected to the first gear, and the second end of the second timing link is connected to the second gear.

11. The lift device of claim 9 wherein the timing mechanism further comprises a movable guide member mounted on the base so that the guide member is movable with respect to the base in upward and downward directions, and wherein the second end of the first timing link is connected to the guide member, and the second end of the second timing link is connected to the guide member.

12. The lift device of claim 9 wherein the timing mechanism further comprises a rotatable member rotatably mounted on the base, and wherein the second end of the first timing link is pivotally connected to the rotatable member, and the second end of the second timing link is pivotally connected to the rotatable member.

13. The lift device of claim 12 wherein the rotatable member comprises a pivot arm.

14. A scissor lift comprising:
a base having first and second pairs of fixed articulation locations;
a link arrangement including first and second pairs of links that are pivotally connected to the first and second pairs of fixed articulation locations, respectively, so that the first pair of links is spaced apart from the second pair of links, and a timing mechanism that is associated with the first and second pairs of links and configured to coordinate movement of the first and second pairs of links so that the first and second pairs of links are pivotable substantially synchronously, wherein the timing mechanism is connected with respect to one of the first and second pairs of links below a plane that extends through the first and second pairs of fixed articulation locations;
a retractable lifting mechanism including multiple foldable support members that are cooperable with each other so that the lifting mechanism is movable between a stowed position and an extended, deployed position, the foldable support members including first and second pairs of lowermost foldable support members that are connected to the first and second pairs of links, respectively, wherein each foldable support member of the first pair of lowermost foldable support members is pivotally coupled to a respective foldable support member of the second pair of lowermost foldable support members with a central pivot pin;
a platform coupled to an upper end of the lifting mechanism; and
an actuator coupled to at least one of the foldable support members for moving the lifting mechanism from the stowed position to the deployed position, wherein the actuator is separate from the timing mechanism;
wherein the first pair of links is configured to pivot about a first pivot axis in a first direction and the second pair of links is configured to pivot about a second pivot axis in a second direction opposite the first direction when the lifting mechanism moves from the stowed position to the deployed position, so that the second pair of links does not overlap the first pair of links when viewed in a direction parallel to the first and second axes, and wherein position of a central plane of the lifting mechanism remains substantially unchanged when the lifting mechanism moves between the stowed position and the deployed position.

15. The scissor lift of claim 14 wherein the timing mechanism includes a single pair of timing links connected to the first and second pairs of links, each timing link of the single pair of timing links including a first end connected to the first pair of links, and a second end connected to the second pair of links.

16. The scissor lift of claim 15 wherein the link arrangement includes a laterally extending member fixedly connected to the first pair of links, and two downwardly extending links that are fixedly connected to the laterally extending member, and wherein the first end of each of the timing links of the single pair of timing links is pivotally connected to a respective one of the downwardly extending links.

17. The scissor lift of claim 16 wherein, for each of the timing links, the first and second ends define first and second connection locations, respectively, and wherein one of the first and second connection locations is positioned below the plane that extends through the first and second pairs of fixed articulation locations, and the other of the first and second connection locations is positioned above the plane.

18. The scissor lift of claim 14 wherein the timing mechanism includes a single timing link having a first end connected to the first pair of links, and a second end connected to the second pair of links.

19. The scissor lift of claim 18 wherein the link arrangement comprises a laterally extending member fixedly connected to the first pair of links, and the first end of the timing link is connected to the laterally extending member.

20. The scissor lift of claim 19 wherein the link arrangement further comprises a downwardly extending connection member fixedly connected to the laterally extending member, and the first end of the timing link is pivotally connected to the downwardly extending connection member.

21. The scissor lift of claim 19 wherein the link arrangement further comprises an additional laterally extending member fixedly connected to the second pair of links, and the second end of the timing link is connected to the additional laterally extending member.

22. The scissor lift of claim 21 wherein the link arrangement further comprises a connection member fixedly connected to the additional laterally extending member, and the second end of the timing link is pivotally connected to the connection member.

23.-31. (canceled)

32. A lift device comprising:
a base;
a lifting mechanism that is movable relative to the base between a stowed position and a deployed position, wherein the lifting mechanism includes first and second support members pivotally coupled together with a central pivot pin;
a link arrangement including first and second links that are spaced apart from each other, and a timing mechanism associated with the first and second links and configured to coordinate movement of the first and second links so that the first and second links are pivotable substantially synchronously; and
a support assembly;
wherein 1) the first and second links are connected to the base at first and second fixed coupling locations and are further connected to a lower end of the lifting mechanism so that the first and second links are pivotally connected to the first and second support members, respectively, or 2) the first and second links are connected to the support assembly at first and second fixed coupling locations and are further connected to an upper end of the lifting mechanism so that the first and second links are pivotally connected to the first and second support members, respectively; and
wherein the first and second links are configured to pivot about first and second pivot axes, respectively, and in opposite directions with respect to each other, without overlapping each other when viewed in a direction parallel to the first and second axes, when the lifting mechanism moves between the stowed position and the deployed position, and wherein the timing mechanism defines a connection location located below or above a plane that extends through the first and second fixed coupling locations.

33. The lift device of claim 32 further comprising an actuator associated with the lifting mechanism and configured to move the lifting mechanism from the stowed position to the deployed position, wherein the actuator is separate from the timing mechanism.
